(19) United States
(12) Patent Application Publication
(10) Pub. No.: US 2025/0033718 A1
(43) Pub. Date: Jan. 30, 2025

(54) ELASTOMERIC ENDLESS TRACK AND METHOD FOR MANUFACTURING SAME

(71) Applicant: SOUCY INTERNATIONAL INC., Drummondville (CA)

(72) Inventors: Eric HALSTEAD, Sainte-Marie-Madeleine (CA); Olivier CHAMPAGNE, Drummondville (CA)

(21) Appl. No.: 18/710,848

(22) PCT Filed: Nov. 23, 2022
(86) PCT No.: PCT/CA2022/051719

§ 371 Date: May 16, 2024

Related U.S. Application Data
(60) Provisional application No. 63/282,269, filed on Nov. 23, 2021.

(51) Int. Cl. B62D 55/24

(52) U.S. Cl. CPC B62D 55/244

(57) ABSTRACT

An elastomeric endless track for a track system is disclosed. The elastomeric endless track has a carcass and a plurality of longitudinally spaced lugs. The carcass has an inner surface engageable by at least one wheel assembly, and an outer surface engageable to a ground surface. The carcass is made of at least a first elastomeric material. The plurality of longitudinally spaced lugs project from the inner surface, define a plurality of inter-lug sections located between adjacent longitudinally spaced lugs. At least some of the plurality of inter-lug sections includes a zone made of at least a second elastomeric material. A method for manufacturing an elastomeric endless track for a track system is also disclosed.

### CROSS-REFERENCE TO RELATED APPLICATION

The present application claims priority to U.S. Provisional Patent Application No. 63/282,269, filed Nov. 23, 2021 entitled “Elastomeric Endless Track and Method for Manufacturing Same”, which is incorporated by reference herein in its entirety.

### TECHNICAL FIELD

The present technology relates to elastomeric endless tracks, methods for manufacturing elastomeric endless tracks, and track systems comprising such elastomeric endless tracks.

### BACKGROUND

Certain vehicles, such as, for example, agricultural vehicles (e.g., harvesters, combines, tractors, etc.), construction vehicles (e.g., bulldozers, front-end loaders, etc.), all-terrain vehicles (ATV) and utility task vehicles (UTV) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle.

In order to reduce the aforementioned drawbacks, wheels have been replaced with track systems having endless tracks.

Conventional endless tracks do, however, present some inconveniences. Conventional endless tracks can induce high rolling resistance to their track systems, and endless tracks can dissipate a significant amount of energy.

Therefore, there is a desire for an endless track that can mitigate the above-mentioned issues.

### SUMMARY

It is an object of the present technology to ameliorate at least some of the inconveniences present in the prior art.

In the context of the following description, “outwardly” or “outward” means away from a longitudinal center plane of the track system, and “inwardly” or “inward” means toward the longitudinal center plane. In addition, in the context of the following description, “longitudinally” means in a direction parallel to the longitudinal center plane of the track system in a plane parallel to flat level ground, “laterally” means in a direction perpendicular to the longitudinal center plane in a plane parallel to flat level ground, and “generally vertically” means in a direction contained in the longitudinal center plane along a height direction of the track system generally perpendicular to flat level ground. In the following description and accompanying Figures, the track system is configured to be attached to a right side of the chassis of the vehicle.

According to one aspect of the present technology, there is provided an elastomeric endless track for a track system. The endless track includes a carcass and a plurality of longitudinally spaced lugs. The carcass has an inner surface engageable by, at least one wheel assembly and an outer surface engageable to a ground surface. The carcass is made of at least a first elastomeric material. The plurality of longitudinally spaced lugs project from the inner surface, and define a plurality of inter-lug sections located between adjacent longitudinally spaced lugs. At least some of the plurality of inter-lug sections includes a zone made of at least a second elastomeric material.

In some embodiments, the second elastomeric material is less viscous than the first elastomeric material.

In some embodiments, each zone of the plurality of inter-lug sections extends longitudinally from a bottom portion of a first lug to a bottom portion of a second lug adjacent to the first lug.

In some embodiments, a width of each zone of the plurality of inter-lug sections is the same as a width of the plurality of longitudinally spaced lugs.

In some embodiments, a width of each zone of the plurality of inter-lug sections spans at least 50% of a width of the carcass.

In some embodiments, the inner surface defines a first wheel engaging portion on a first side of the plurality of longitudinally spaced lugs, and a second wheel engaging portion on a second side of the plurality of longitudinally spaced lugs, and each zone of the plurality of inter-lug sections extends from the first wheel engaging portion to the second wheel engaging portion.

In some embodiments, each zone of the plurality of inter-lug sections has a leading portion, an intermediate portion and a trailing portion. The leading portion has a first thickness, the intermediate portion has a second thickness and the trailing portion has a third thickness. The first and third thicknesses are smaller than the second thickness.

In some embodiments, the intermediate portion of each zone of the plurality of inter-lug sections is generally centered in the inter-lug section.

In some embodiments, the intermediate portion of each zone of the plurality of inter-lug sections is offset from a center of the inter-lug section.

In some embodiments, each zone of the plurality of inter-lug sections has a leading portion, an intermediate portion and a trailing portion, the leading portion has a first thickness, the intermediate portion has a second thickness and the trailing portion has a third thickness, and the first, second and third thickness are the same.

In some embodiments, the first, second and third thicknesses measure 0.1 inches.

In some embodiments, a ratio between a thickness of the second elastomeric material over a thickness of the first elastomeric material at some of the plurality of inter-lug sections is about at least 5%.

In some embodiments, a ratio between a thickness of the second elastomeric material over a thickness of the first elastomeric material at some of the plurality of inter-lug sections is about at least 30%.

In some embodiments, a ratio between a thickness of the second elastomeric material over a thickness of the first elastomeric material at some of the plurality of inter-lug sections is about at least 45%.

In some embodiments, each zone of the plurality of inter-lug sections defines a generally rectangular shape.

In some embodiments, each zone of the plurality of inter-lug sections has a protective layer, where the protective layer is made of a third material.

In some embodiments, the third material is the same as the first elastomeric material.

In some embodiments, a first deformation energy of the first elastomeric material is greater than a second deformation energy of the second elastomeric material.

In some embodiments, upon deformation of the first and second elastomeric materials, the first elastomeric material dissipates more heat than the second elastomeric material.

In some embodiments, upon deformation of the endless track, each zone of the plurality of inter-lug sections dissipates less energy than a corresponding sized zone of the carcass.

In some embodiments, the first elastomeric material has first mechanical properties, the second elastomeric material has second mechanical properties and the first mechanical properties are different from the second mechanical properties.

In some embodiments, the first elastomeric material has first viscoelastic properties, the second elastomeric material has second viscoelastic properties and the first viscoelastic properties are different from the second viscoelastic properties.

In some embodiments, the at least one second elastomeric material is a composite elastomeric material.

In some embodiments, a presence of the plurality of inter-lug sections reduces a rolling resistance of the endless track by about 5%.

In some embodiments, the rolling resistance of the endless track is less than about 70 Nm when a temperature within the endless track is about 40° C.

In some embodiments, the first elastomeric material has a first storage modulus over loss modulus ratio, the second elastomeric material has a second storage modulus over loss modulus ratio, and the first storage modulus over loss modulus ratio is greater than the second storage modulus over loss modulus ratio.

In another aspect of the present technology, there is provided a track system including a frame, wheel assemblies rotationally connected to the frame and the elastomeric endless according to the above aspect or according to the above aspect and one or more of the above embodiments. The endless track surrounds the frame and the wheel assemblies.

In some embodiments, the wheel assemblies include a sprocket wheel assembly rotationally connected to the frame and operatively connectable to a driving axle, the sprocket wheel assembly being configured to engage the plurality of longitudinally spaced lugs.

In some embodiments, the track system has a rolling resistance and the at least some of the plurality of inter-lug sections being configured to dissipate less deformation energy than the rest of the carcass, thereby reducing the rolling resistance.

According to another aspect of the present technology, there is provided a method for manufacturing an elastomeric endless track for a track system. The method includes forming a carcass having a plurality of longitudinally spaced lugs, the carcass having an inner surface configured to engage with at least one wheel assembly and an outer surface configured to engage a ground surface. The carcass is made of at least a first elastomeric material. The plurality of longitudinally spaced lugs defines a plurality of inter-lug sections located between two adjacent longitudinally spaced lugs. At least some of the plurality of inter-lug sections includes a zone made of at least a second elastomeric material.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a right side elevation view of a harvester having a track system with an endless track;

FIG. 2 is a perspective view taken from a top, front, left side of a portion of the endless track of FIG. 1;

FIG. 3 is a top plan view of the portion of the endless track of FIG. 2;

FIG. 4 is a perspective view taken from a bottom, rear, right side of the portion of the endless track of FIG. 2;

FIG. 5A is a cross-sectional view of the portion of the endless track taken across the line 5A-5A of FIG. 3;

FIG. 5B is a close-up of a section of the portion of the endless track taken from FIG. 5A;

FIG. 6 is a top plan view of a portion of an alternative embodiment of the endless track of FIG. 1;

FIG. 7A is a cross-sectional view taken across the line 7A-7A of FIG. 6;

FIG. 7B is a close-up of a section of the portion of the endless track taken from FIG. 7A; and

FIG. 8 is a close-up of a section of a portion of an alternative embodiment of the endless track of FIG. 1.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to various embodiments of an endless track, and will be described with reference to a track system.

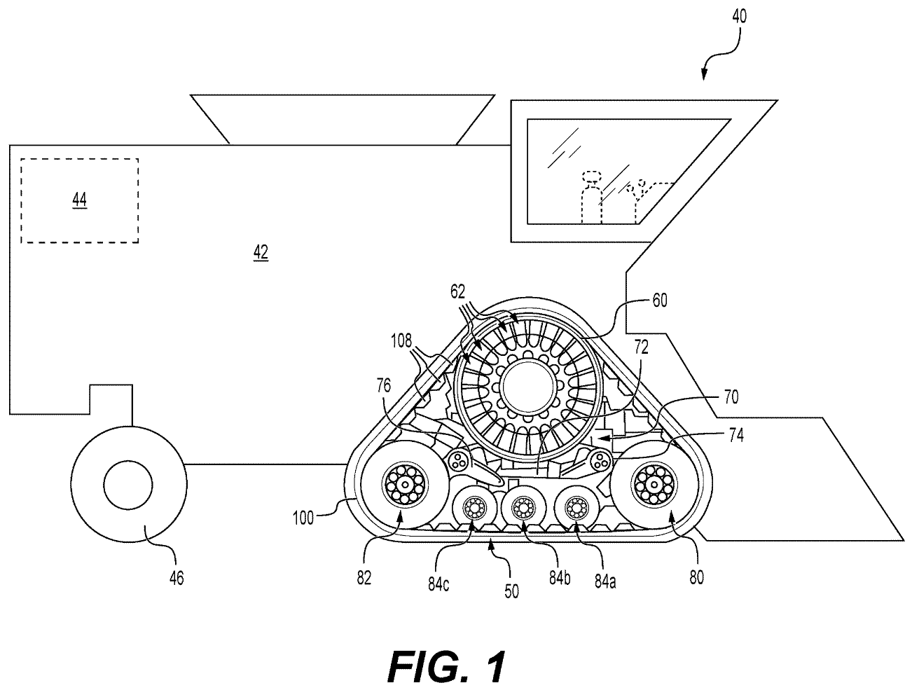

Referring to FIG. 1, a harvester 40 is shown. The harvester 40 has a frame 42 that houses an engine 44 (shown schematically). The harvester 40 also has left and right rear wheels 46 and left and right track systems 50 (only right rear wheel 46 and right track system 50 are shown in the accompanying Figures). It is contemplated that in some embodiments, the harvester 40 could have more than two track systems. The engine 44 is operatively connected to left and right track systems 50. It is contemplated that in some embodiments, the engine 44 could be operatively connected to the rear wheels 46. It is understood that the present technology could be used with other vehicles such as bulldozers, skid-steer loaders, excavators and/or compact track loaders. Additionally, the present technology could also be used with other vehicles such as all-terrain-vehicles, snowmobiles, side-by-side vehicles or utility-terrain vehicles. It is further contemplated that the present technology could be used with industrial and military vehicles. It is also contemplated that the present technology could be used with trailers or other unpowered vehicles.

Still referring to FIG. 1, the track system 50 has a sprocket wheel assembly 60 that is operatively connected to an axle (not shown) of the harvester 40, such that when the axle rotates, the sprocket wheel assembly 60 also rotates, thereby driving the track system 50. It is contemplated that in some embodiments, the sprocket wheel assembly 60 could be configured to connect to a non-driving axle of a vehicle. The sprocket wheel assembly 60 defines a plurality of recesses 62. The plurality of recesses 62 are defined circumferentially on a periphery of the sprocket wheel assembly 60. The recesses 62 are configured to, as will be described in greater detail below, engage with lugs 108 provided on an inner surface 104 of the endless track 100.

The track system also has a frame 70 that is rotationally connected to the sprocket wheel assembly 60 and that is disposed laterally inwardly therefrom. It is contemplated that in other embodiments, the frame 70 could be disposed laterally outwardly from the sprocket wheel assembly 60. The frame 70 has a main frame member 72, a leading frame member 74 and a trailing frame member 76 where the leading and trailing frame members 74, 76 are pivotally connected to the main frame member 72.

The track system 50 includes wheel assemblies. More precisely, the track system 50 includes, in addition to the sprocket wheel assembly 60, a front idler wheel assembly 80, a rear idler wheel assembly 82 and three support wheel assemblies 84a, 84b, 84c which are disposed longitudinally between the front and rear idler wheel assemblies 80, 82. It is contemplated that in some embodiments, the track system 50 could have more or less than three support wheel assemblies.

The front idler wheel assembly 80 and the support wheel assembly 84a are rotationally connected to the leading frame member 74. The support wheel assemblies 84b, 84c are connected to form a tandem 86 which in turn is pivotally connected to the trailing frame member 76. The rear idler wheel assembly 82 is also rotationally connected to the trailing frame member 76. Thus, the track system 50 is configured to, to some extent, conform to encountered obstacles.

Each one of the front and rear idler wheel assemblies 80, 82, and the support wheel assemblies 84a, 84b, 84c has two laterally spaced wheels, such that each one of the front and rear idler wheel assemblies 80, 82, and the support wheel assemblies 84a, 84b, 84c has a left wheel and a right wheel (only right wheel of each of the wheel assemblies is shown in FIG. 1). It is contemplated that in some embodiments, one or more of the front and rear idler wheel assemblies 80, 82, and the support wheel assemblies 84a, 84b, 84c could be configured to have a single wheel or three or more wheels.

It is contemplated that in some embodiments, the track system 50 could include a tensioner that is configured to adjust tension in the endless track 100.

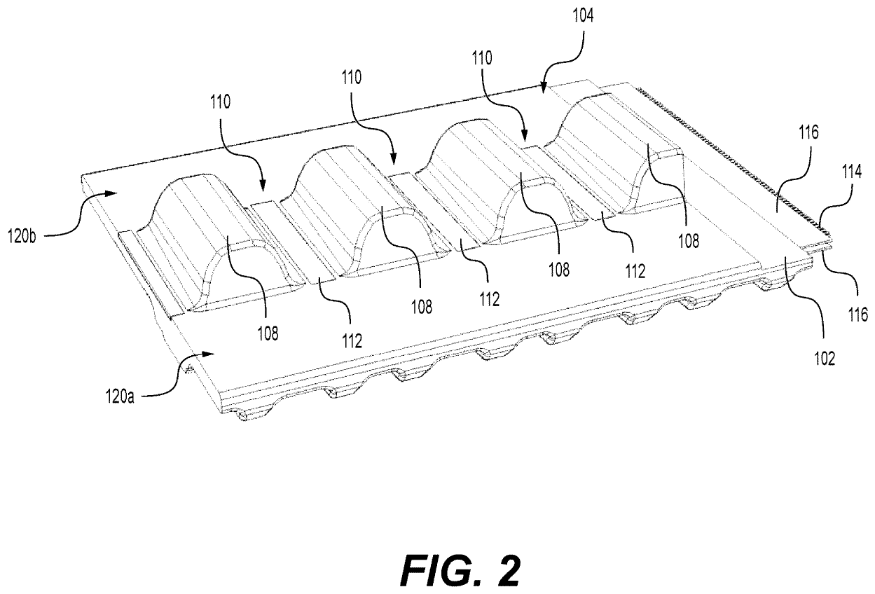

The track system 50 also includes the endless track 100, which will now be described in greater detail with reference to FIGS. 2 to 4. The endless track 100 extends around components of the track system 50, such that the endless track 100 surrounds the sprocket wheel assembly 60, the frame 70, the front and rear idler wheel assemblies 80, 82, and the support wheel assemblies 84a, 84b, 84c.

In some embodiments, the endless track 100 is an elastomeric endless track, and includes a carcass 102, and a plurality of longitudinally spaced lugs 108.

The carcass 102 has an inner surface 104 that is configured to be engaged by the front and rear idler wheel assemblies 80, 82 and the support wheel assemblies 84a, 84b, 84c. The carcass 102 also has an outer surface 106 that is configured to engage a ground surface. Embedded in the carcass 102, between the inner and outer surfaces 104, 106, the endless track 100 has longitudinally extending reinforcing cables 114 and reinforcing sheets 116. The reinforcing cables and sheets 114, 116 are configured to generally limit longitudinal elongation of the carcass 102 and/or limit the longitudinal deformation. Thus, the reinforcing cables and sheets 114, 116 reinforce the endless track 100, which can assist in reducing the likelihood of the endless track 100 from being torn and/or damaged, and can thereby prolong a life of the endless track 100. It is contemplated that in some embodiments, the reinforcing cables 114 and/or the reinforcing sheets 116 could be omitted. The carcass 102 is made of a first elastomeric material. It is contemplated that the first elastomeric material could be a polymeric material.

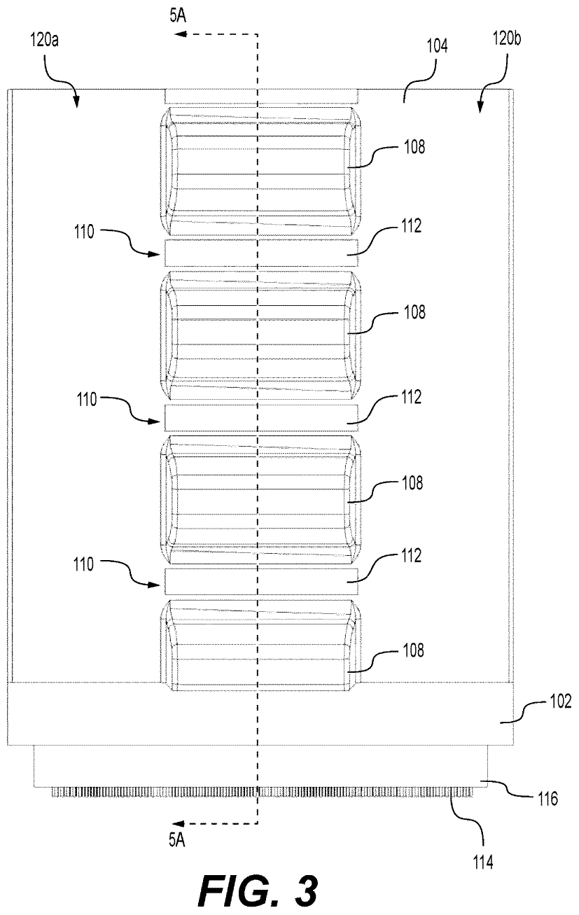

Referring to FIGS. 2 and 3 and focusing first on the inner surface 104, the lugs 108 project from the inner surface 104. More specifically, in the present embodiment, the lugs 108 are disposed generally centrally along a width of the inner surface 104. The lugs 108 are configured to engage with teeth of the sprocket wheel assembly 60. It is contemplated that in some embodiments, the carcass 102 could have two or more laterally spaced sets of longitudinally spaced lugs 108. Longitudinally between two adjacent lugs 108, there is defined an inter-lug section 110. Thus, there is an inter-lug section 110 between each two adjacent lugs 108. Each of the inter-lug section 110 has a flexible zone 112, which will be described in greater detail below. It is contemplated that in some embodiments, the flexible zone 112 could be present in only some of the inter-lug sections 110.

On the left and right sides of the lugs 108, the inner surface 104 has, respectively, wheel engaging sections 120a, 120b which are configured to engage with respectively, the left and right wheels of the front and rear idler wheel assemblies 80, 82, and the left and right wheels of the support wheel assemblies 84a, 84b, 84c. The wheel engaging sections 120a, 120b, which extend longitudinally along the endless track 100, are generally flat. It is contemplated that in some embodiments, laterally outwardly from the wheel engaging sections 120a, 120b, the inner surface 104 could define recesses in the carcass 102 that could reduce the amount of material required to manufacture the endless track 100, and thus, could, in some instances, help to reduce rolling resistance induced by the endless track 100.

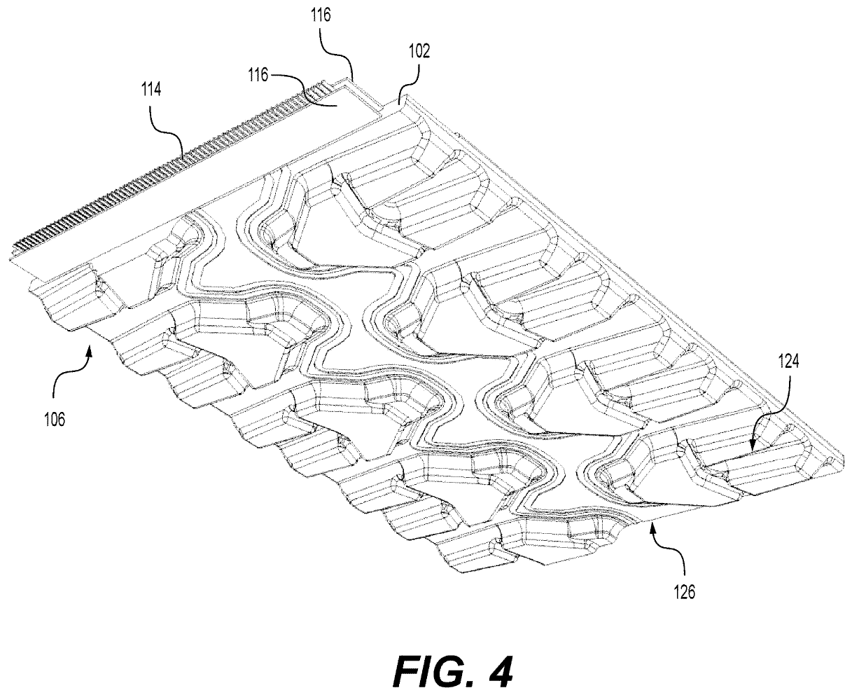

Referring now to FIG. 4, the outer surface 106 of the endless track 100 has ridges 124 that form a tread 126. It is contemplated that the tread 126 could vary in shape and dimension from one embodiment to another. In some embodiments, the tread 126 could depend on the type of vehicle to which the track system 50 is to be mounted and/or the type of ground surface on which the vehicle is destined to travel. Thus, spacing between the ridges 124 can, to some extent, vary depending on the ground surface on which the endless track 100 is to be used, on the type of vehicle on which the endless track 100 is to be used, etc.

Referring to FIGS. 2, 3, 5A and 5B, the flexible zones 112 will now be described in greater detail. As mentioned above, in the present embodiment, each of the inter-lug sections 110 has one flexible zone 112 such that endless track 100 has a plurality of flexible zones 112. As the plurality of flexible zones 112 are generally similar, only one flexible zone 112 will be described herewith.

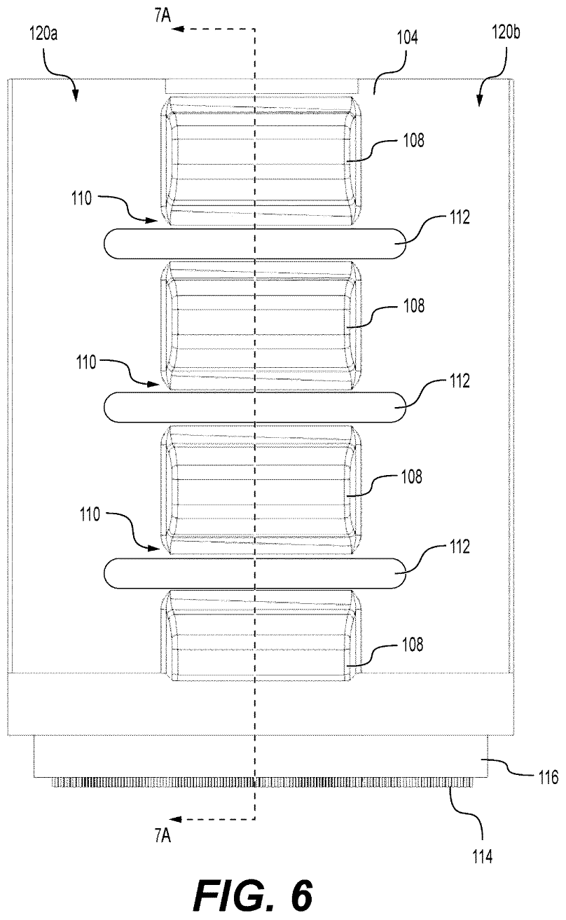

The flexible zone 112, as seen from a top plan view (FIG. 3) defines a generally rectangular shape. It is contemplated, however, that in some embodiments, the flexible zone 112 could define another shape such as an elliptical shape (FIG. 6) or a circular shape.

The flexible zone 112, which has a leading portion 130, an intermediate portion 132 and a trailing portion 134, extends from a bottom portion of one lug 108 to a bottom portion of an adjacent lug 108. More precisely, the flexible zone 112 extends from a root of one of the lugs 108 to a root of the adjacent lug 108, such that the leading portion 130 starts at the root of one of the lugs 108, the trailing portion 134 ends at the root of the adjacent lug 108 and the intermediate portion 132 is generally centered in the inter-lug section (i.e., centered between the two adjacent lugs 108). In some embodiments, the flexible zone 112 could extend from below one of the lugs 108 to below the adjacent lug 108, such that the leading portion 130 starts below one of the lugs 108 and the trailing portion 134 ends below the adjacent lug 108.

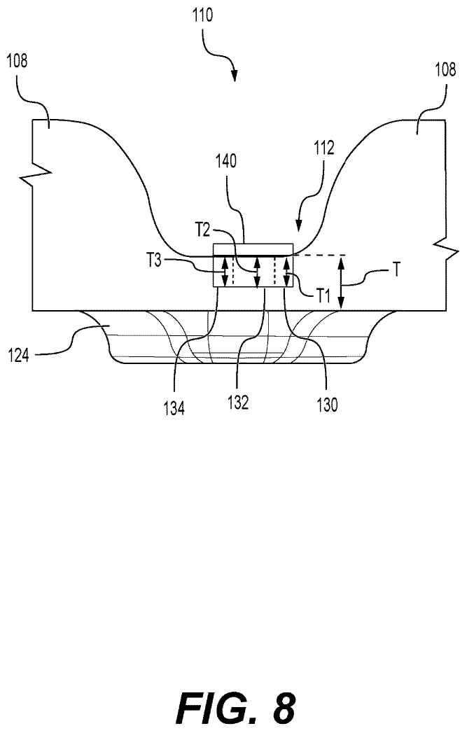

Referring to FIG. 8, in some embodiments, the flexible zone 112 extends from a point longitudinally spaced from one lug 108 to a point longitudinally spaced from the adjacent lug 108 such that the leading portion 130 is longitudinally spaced from one of the lugs 108 and the trailing portion 134 is longitudinally spaced from the adjacent lug 108 (i.e., the flexible zone 112 is spaced from the lugs 108). In the embodiment shown in FIG. 8, the intermediate portion 132 is offset from a center of the inter-lug section 110.

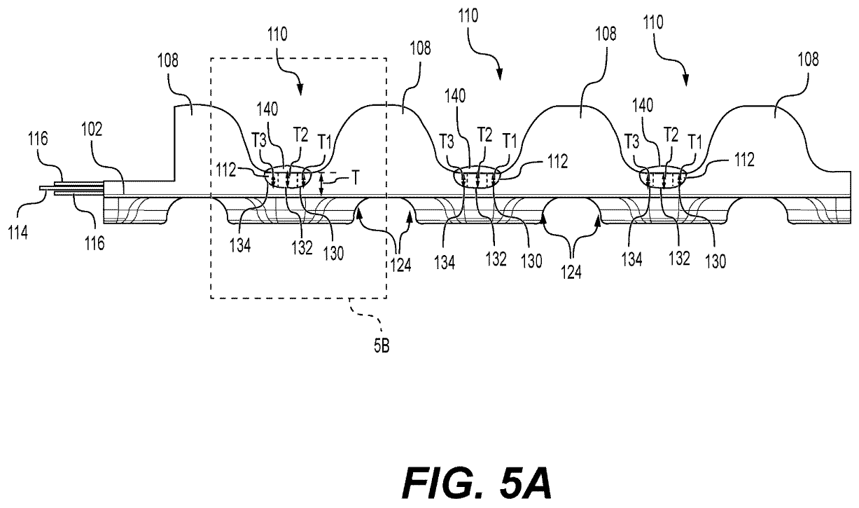

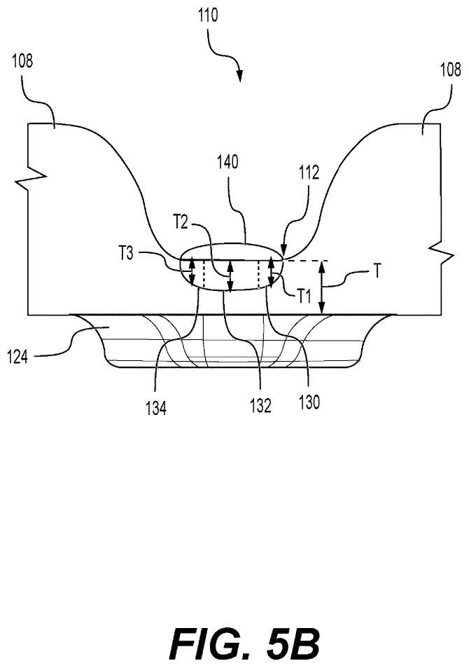

Referring to FIGS. 5A and 5B, the leading portion 130 has a thickness T1, the intermediate portion 132 has a thickness T2, the trailing portion 134 has a thickness T3 and the carcass 102 has an overall thickness T at the inter-lug section 10. The overall thickness T does not include the lugs 108 or the ridges 124. The thickness T2 is greater than the thicknesses T1 and T3. It is contemplated that in some embodiments, the thickness T1 could be greater than the thicknesses T2 and T3. In other embodiments, the thickness T1 could be less than T2 and T3. Any such variation is contemplated. A thickness ratio defined as being one of the thicknesses T1, T2, T3 over the thickness T is about at least about 5%, at least about 6%, at least about 7%, at least about 8%, at least about 9%, at least about 10%. In other embodiments, the thickness ratio is about at least about 15%, at least about 20%, at least about 25%, at least about 30%, at least about 35% or at least about 40%. In yet other embodiments, the thickness ratio is about at least about 45%. In some instances, the thickness ratio is defined as being one of the thicknesses T1, T2, T3 over the thickness of the first material.

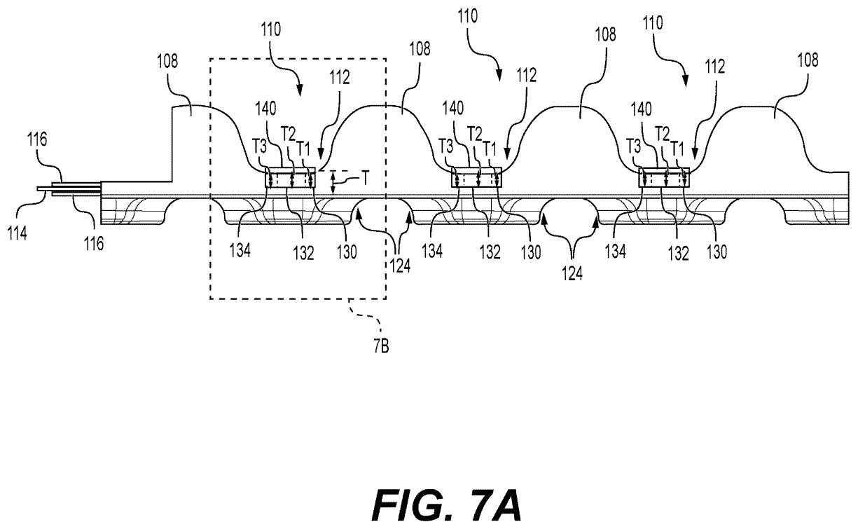

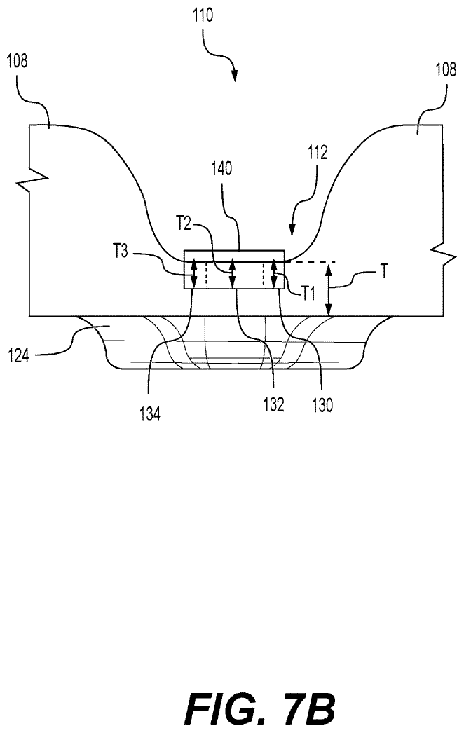

In an alternative embodiment of the present technology, shown in FIGS. 6, 7A and 7B, the thicknesses T1, T2, T3 are the same (i.e., the flexible zone 112 has one uniform thickness). In this embodiment, the thicknesses T1, T2 and T3 measure about 0.2 inches. It is contemplated that the thicknesses T1, T2, T3 could be more or less than about 0.2 inches. For instance, in some embodiments, the thicknesses T1, T2, T3 could be about 0.05 inches, about 0.075 inches, about 0.1 inches, about 0.125 inches, about 0.15 inches and/or about 0.175 inches. In yet other embodiments, the thicknesses T1, T2, T3 could be about 0.4 inches, about 0.375 inches, about 0.35 inches, about 0.325 inches, about 0.3 inches, about 0.275 inches, about 0.250 inches or about 0.225 inches. In some embodiments, similarly to what is described above, a thickness ratio defined as being one of the thickness T1, T2 or T3 over the thickness T of the carcass 102 is about at least about 5%, at least about 6%, at least about 7%, at least about 8%, at least about 9%, at least about 10%. In other embodiments, the thickness ratio is about at least about 15%, at least about 20%, at least about 25%, at least about 30%, at least about 35% or at least about 40%. In yet other embodiments, the thickness ratio is about at least about 45%.

Referring back to FIGS. 3, 5A and 5B, a width of the flexible zone 112 is generally similar to a width of one of the lugs 108, where the width of each of the lugs 108 is measured from an outermost portion of one lateral side of lug 108 to an outermost portion of the other lateral side of the lug 108. Being that the outermost portions of the lugs 108 are proximate to the wheel engaging portions 120a, 120b, the flexible zone 112 extends laterally from the wheel engaging portion 120a to the wheel engaging portion 120b. In some embodiments, the width of the flexible zone 112 could change from one of the leading, intermediate and trailing portions 130, 132, 134 to another. For instance, the width at the intermediate portion 132 could be greater than the width at the leading and trailing portions 130, 134). It is contemplated that in some embodiments, the width of the flexible zone 112 could be wider than the width of the lugs 108.

In the embodiment shown in FIGS. 6, 7A and 7B, the width of the flexible zone 112 is greater than the width of the lugs 108. In this embodiment, the flexible zone 112 spans at least about 60% of a width of the carcass 102. In some embodiments, the flexible zone 112 could span at least about 50% of a width of the carcass 102. In other embodiments, the flexible zone 112 could span at least about 70% of a width of the carcass 102. The width of the flexible zone 112 varies from the intermediate portion 132 to the leading and trailing portions 130, 134 such that the width at the intermediate portion 132 is greater than the width at the leading and trailing portions 130, 134.

The flexible zone 112 also has a protective layer 140 on a top thereof. In some embodiments, the protective layer 140 is omitted. The protective layer 140 can protect the flexible zone 112 from the sprocket wheel assembly 60 when the sprocket wheel assembly 60 engages the endless track 100. The protective layer 140 is made of the first elastomeric material. It is contemplated that in other embodiments, the protective layer 140 could be made of another material.

In some embodiments, the flexible zone 112 is made of at least a second elastomeric material. In other embodiments, the second elastomeric material is a combination of the first elastomeric material and another material. In some embodiments, the second elastomeric material is a composite elastomeric material.

Properties of the second elastomeric material are different from the properties of the first elastomeric material. For instance, the second elastomeric material is more elastic than the first elastomeric material. In addition, the viscoelastic properties of the second elastomeric material are different from the viscoelastic properties of the first elastomeric material, such that the second elastomeric material is less viscous than the second elastomeric material. Thus, the energy required to deform the first elastomeric material is greater than the energy required to deform the second elastomeric material (i.e., the deformation energy of the first elastomeric is greater than the deformation energy for the second elastomeric material).

Viscoelastic properties of viscoelastic material can be determined with the following equation:

$$tan ( δ ) = \frac{{G}^{′}}{{G}^{″}} \qquad ( 1 )$$

where
δ is a phase lag between stress and strain;
G′ is shear storage modulus; and
G″ is shear loss modulus

Thus, since the second elastomeric material is less viscous than the first elastomeric material, a magnitude of the tan(δ) parameter of the second elastomeric material is less than a magnitude of the tan(δ) parameter of the first elastomeric material.

Were the flexible zones 112 not made of the second elastomeric material, the endless track 100 would be made with more of the first elastomeric material. In other words, at the flexible zones 112, the second elastomeric material replaces the first elastomeric material. This, as will be described below, can help reduce energy dissipated by the endless track 100.

As will be described in greater detail below, the presence of the flexible zones 112, along with the features described hereabove, can assist in reducing energy dissipated by the endless track 100 when the endless track 100 is being deformed. In some instances, the presence of the flexible zones 112 can help reduce energy dissipated at the inter-lug sections 110.

During operation, when the axle to which the sprocket wheel assembly 60 is operatively connected rotates, the sprocket wheel assembly 60 also rotates such that the sprocket wheel assembly 60 engages, and thus drives, the endless track 100. More precisely, the recesses 62 of the sprocket wheel assembly 60 engage with the lugs 108 of the endless track 100. The transmission of force and motion result in the endless track 100 experiencing relatively high stresses at the lugs 108 and within the carcass 102. In some instances, the stresses can be high at the root of the lugs 108. Generally, the sprocket wheel assembly 60 and the endless track 100 are configured so that a radial surface of the sprocket wheel assembly 60 does not engage with the inner surface 102 of the endless track 100 between the lugs 108 (i.e. the sprocket wheel assembly 60 does not apply shear or compressive forces at the inter-lug sections 110). In some instances, the radial surface of the sprocket wheel assembly 60 may contact the endless track 100 at the inter-lug sections 110. In such instances, the protective layer 140 at each inter-lug section 110 is configured to engage the radial surface of the sprocket wheel assembly 60 first, and thus protect its corresponding flexible zone 112 as well as the inner surface 102 from premature wear.

During operation, the track system 50 is subject to rolling resistance. Thus, there is energy loss in the track system 50. The endless track 100 contributes to the rolling resistance of the track system 50. For example, bending resistance of the endless track 100 can contribute to the rolling resistance of the track system 50. Part of the rolling resistance, and thus the energy dissipated by the endless track 100 is attributed to the hysteresis of the endless track 100.

Being that the lugs 108 and the carcass 102 are made of the first elastomeric material, which has higher hysteresis than the second elastomeric material, the lugs 108 and the carcass 102, when deformed, dissipate more energy than the flexible zone 112. The first elastomeric material is used despite being a source of energy dissipation, because the first elastomeric material is configured to withstand the high stresses that the lugs 108 and the carcass 102 are subjected to. In other words, the first elastomeric material is configured to, at least to some degree, prevent or reduce tearing of or damage to the lugs 108 and the carcass 102 caused by high stresses. In some embodiments, the properties of the first elastomeric material that exacerbate energy dissipation also serve to prevent or reduce tearing of or damage to the lugs 108 and the carcass 102.

Being that the flexible zones 112 are made of the second elastomeric material, which has lower hysteresis than the first elastomeric material, each of the flexible zones 112 is configured to dissipate less energy than a corresponding sized zone of the carcass 102. The flexible zones 112 are present, and made with the second elastomeric material, because stresses at the flexible zones 112 are, generally, not as high as stresses at the lugs 108 and the carcass 102. Thus, the second elastomeric material, which is configured to resiliently deform more easily and to dissipate less energy than the first elastomeric material, but provide less protection against tears and damages than the first elastomeric material, can be used.

The presence of the flexible zones 112 can therefore reduce the rolling resistance of the track system 50 and can reduce the energy dissipated by the endless track 100, because the energy required to deform the endless track 100 (i.e., an endless track having the flexible zones 112 (i.e., deformation energy)) is less than the energy required to deform an endless track without the flexible zones 112. In some embodiments, the presence of the flexible zones 112 can reduce the rolling resistance of the endless track 100 by about 5%, by about 6% or by about 7%. In other embodiments, the presence of the flexible zones 112 can reduce the rolling resistance of the endless track 100 by about 4%, by about 3% or by about 2%. In some instances, the presence of the flexible zones 112 is such that the rolling resistance of the endless track 100 is less than about 70 Nm when a general temperature within the endless track 100 is about 40° C.

In some embodiments, the presence of the flexible zones 112 can reduce the energy dissipated by the endless track 100 by at least about 5%. In other embodiments, the presence of the flexible zones 112 could reduce the energy dissipated by the endless track 100 by at least about 7%. In other embodiments, the presence of the flexible zones 112 could reduce the energy dissipated by the endless track 100 by at least about 10%.

A method for manufacturing the endless track 100 will now be described.

The carcass 102 having the lugs 108 is formed using methods known in the art. For instance, the carcass 102 and the lugs 108 could be molded and then cured into shape. The carcass 102 and the lugs 108 are made of the first elastomeric material.

The method also comprises forming the flexible zones 112 with the second elastomeric material.

In some embodiments, the flexible zones 112 are formed on endless tracks that are already formed and/or that have already been used. In such embodiments, it is contemplated that a portion of the first elastomeric material between the lugs 108 is removed to accommodate a flexible zone 112, and the second elastomeric material is disposed between the lugs 108 and then cured, thus forming the flexible zone 112.

The various components of the track system 50 are made of conventional materials (e.g., metals and metal alloys in most cases, such as steel) via conventional manufacturing processes (e.g., casting, molding, etc.). The present technology does not require any specific materials nor methods of manufacture. The present technology merely requires that each component be suitable for the purpose for which it is intended and the use to which it is to be put. Any material(s) or method(s) of manufacture which produce such components may be used in the present technology.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims

1. An elastomeric endless track for a track system, the endless track comprising:
a carcass having an inner surface engageable by at least one wheel assembly and an outer surface engageable to a ground surface, the carcass being made of at least a first elastomeric material;
a plurality of longitudinally spaced lugs projecting from the inner surface, the plurality of longitudinally spaced lugs defining a plurality of inter-lug sections located between adjacent longitudinally spaced lugs; and
wherein at least some of the plurality of inter-lug sections comprise a zone made of at least a second elastomeric material.

2. The elastomeric endless track of claim 1, wherein the second elastomeric material is less viscous than the first elastomeric material.

3. The elastomeric endless track of claim 1, wherein each zone of the plurality of inter-lug sections extends longitudinally from a bottom portion of a first lug to a bottom portion of a second lug adjacent to the first lug.

4. The elastomeric endless track of claim 1, wherein a width of each zone of the plurality of inter-lug sections is the same as a width of the plurality of longitudinally spaced lugs.

5. The elastomeric endless track of claim 1, wherein a width of each zone of the plurality of inter-lug sections spans at least 50% of a width of the carcass.

6. The elastomeric endless track of claim 1, wherein the inner surface defines a first wheel engaging portion on a first side of the plurality of longitudinally spaced lugs, and a second wheel engaging portion on a second side of the plurality of longitudinally spaced lugs, and each zone of the plurality of inter-lug sections extends from the first wheel engaging portion to the second wheel engaging portion.

7. The elastomeric endless track of claim 1, wherein:
each zone of the plurality of inter-lug sections has a leading portion, an intermediate portion and a trailing portion,
the leading portion has a first thickness, the intermediate portion has a second thickness and the trailing portion has a third thickness, and
the first and third thicknesses are smaller than the second thickness.

8. The elastomeric endless track of claim 7, wherein the intermediate portion of each zone of the plurality of inter-lug sections is generally centered in the inter-lug section.

9. The elastomeric endless track of claim 7, wherein the intermediate portion of each zone of the plurality of inter-lug sections is offset from a center of the inter-lug section.

10. The elastomeric endless track of claim 1, wherein each zone of the plurality of inter-lug sections has a leading portion, an intermediate portion and a trailing portion, the leading portion has a first thickness, the intermediate portion has a second thickness and the trailing portion has a third thickness, and the first, second and third thickness are the same.

11. (canceled)

12. The elastomeric endless track of claim 1, wherein a ratio between a thickness of the second elastomeric material over a thickness of the first elastomeric material at some of the plurality of inter-lug sections is about at least 5%.

13.-15. (canceled)

16. The elastomeric endless track of claim 1, wherein each zone of the plurality of inter-lug sections has a protective layer, where the protective layer is made of a third material.

17. The elastomeric endless track of claim 16, wherein the third material is the same as the first elastomeric material.

18. The elastomeric endless track of claim 1, wherein a first deformation energy of the first elastomeric material is greater than a second deformation energy of the second elastomeric material.

19. The elastomeric endless track of claim 1, wherein upon deformation of the first and second elastomeric materials, the first elastomeric material dissipates more heat than the second elastomeric material.

20. The elastomeric endless track of claim 1, wherein upon deformation of the endless track, each zone of the plurality of inter-lug sections dissipates less energy than a corresponding sized zone of the carcass.

21.-23. (canceled)

24. The elastomeric endless track of claim 1, wherein a presence of the plurality of inter-lug sections reduces a rolling resistance of the endless track by about 5%.

25. The elastomeric endless track of claim 24, wherein the rolling resistance of the endless track is less than about 70 Nm when a temperature within the endless track is about 40° C.

26. The elastomeric endless track of claim 1, wherein:
the first elastomeric material has a first storage modulus over loss modulus ratio;
the second elastomeric material has a second storage modulus over loss modulus ratio, and
the first storage modulus over loss modulus ratio is greater than the second storage modulus over loss modulus ratio.

27. A track system comprising:
a frame;
wheel assemblies rotationally connected to the frame; and
the elastomeric endless track of claim 1, the endless track surrounding the frame and the wheel assemblies.

28.-30. (canceled)
